(19) United States
(12) Patent Application Publication
(10) Pub. No.: US 2022/0309424 A1
(43) Pub. Date: Sep. 29, 2022

(54) DISPLAY OF RESOURCES BASED ON CONTEXT

(71) Applicant: CITRIX SYSTEMS, INC., FORT LAUDERDALE, FL (US)

(72) Inventors: ZE CHEN, NANJING (CN); ZONGPENG QIAO, NANJING (CN); XIAO ZHANG, NANJING (CN)

(21) Appl. No.: 17/237,159

(22) Filed: Apr. 22, 2021

Related U.S. Application Data
(63) Continuation of application No. PCT/CN2021/082297, filed on Mar. 23, 2021.

(51) Int. Cl. G06Q 10/06; G06F 11/32; G06F 11/34; G06F 16/2457

(52) U.S. Cl. CPC G06Q 10/06312; G06F 11/328; G06F 11/3438; G06F 16/24575; G06Q 10/063114; G06Q 10/063116

(57) ABSTRACT

A computing device includes a display and a processor coupled to the display. The processor is to determine an activity to be completed with use of the computing device, and identify at least one resource accessible to the computing device and to be used to complete the activity. The processor presents on the display at least one identified resource to enable completion of the activity, and adjusts presentation of other resources so as to hide the other resources from display on the computing device.

### RELATED APPLICATIONS

This application is a continuation of PCT application serial no. PCT/CN2021/082297 filed Mar. 23, 2021, which is hereby incorporated herein in its entirety by reference.

### TECHNICAL FIELD

The present disclosure relates to computer systems, and more particularly, to display of resources on a computing device.

### BACKGROUND

In a typical work day, users are able to access, create, and share an ever-increasing amount of information through their computing devices. This information is readily accessible from a wide range of workspace resources.

These resources include desktops, which may be a local desktop or a virtual desktop. Other resources include applications, files and data. Yet other resources include browser tabs, emails, messaging channels, etc. Consequently, users may have a large amount of information displayed on their screen.

### SUMMARY

A computing device includes a display and a processor coupled to the display. The processor is to determine an activity to be completed with use of the computing device, and identify at least one resource accessible to the computing device and to be used to complete the activity. The processor presents on the display at least one identified resource to enable completion of the activity, and adjusts presentation of other resources so as to hide the other resources from display on the computing device.

The processor may be further configured to display a plurality of resources, and access at least one data source accessible to the computing device to determine a context of the activity to be completed. Metadata of the plurality of displayed resources are read to identify the at least one resource associated with the activity to be completed based on the determined context.

The processor may be further configured, in response to accessing the at least one data source, to identify at least one keyword to be used in determining the context of the activity to be completed.

The activity to be completed may be a current activity, and the processor may be further configured to determine a next activity to be completed after the current activity has been completed, and to repeat the identify, present and adjust steps for the next activity.

The processor may be further configured, in response to user input, to determine the activity to be completed.

The resources may include at least one of desktops, applications, files, browser tabs, emails, and messaging channels. The resources may be displayed in a plurality of respective windows.

The processor may be further configured to track scheduled meetings accessible to the computing device, with the scheduled meetings for a user of the computing device. One of the scheduled meetings may be used to determine the activity to be completed.

The processor may be further configured to track tasks accessible to the computing device, with the tasks to be performed by a user of the computing device. One of the tasks may be used to determine the activity to be completed.

The processor may be further configured to track past activities performed by a user of the computing device, and use one of the past activities to anticipate the activity to be completed.

Another aspect is directed to a method of operating a computing device. The method includes determining an activity to be completed with use of the computing device, and identifying at least one resource accessible to the computing device and to be used to complete the activity. The method further includes presenting on the display at least one identified resource to enable completion of the activity, and adjusting presentation of other resources so as to hide the other resources from display on the computing device.

Yet another aspect is directed to a non-transitory computer readable medium for a computing device, and with the non-transitory computer readable medium having a plurality of computer executable instructions for causing the computing device to perform steps as described above.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing device providing a focused mode to display resources in response to a current activity to be completed by a user of the computing device.

FIG. 7 is a screen shot of browser tabs being displayed prior to enabling the focused mode for the computing device illustrated in FIG. 6.

FIG. 8 is a screen shot of the browser tabs illustrated in FIG. 7 being displayed after enabling the focused mode for the computing device.

FIG. 9 is a screen shot of a desktop workspace being displayed prior to enabling the focused mode for the computing device illustrated in FIG. 6.

FIG. 10 is a screen shot of the desktop workspace illustrated in FIG. 9 being displayed after enabling the focused mode for the computing device.

FIG. 11 is a block diagram of the system architecture for providing the focused mode for the computing device illustrated in FIG. 6.

FIG. 12 is a sequence diagram for providing the focused mode for the system architecture illustrated in FIG. 11.

FIG. 13 is a flow diagram for operating the computing device illustrated in FIG. 6.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout, and prime notation is used to indicate similar elements in different embodiments.

Displaying a large amount of information on a user's computing device allows instant access to this information. However, the display of such a large amount of information is not without its problems. One problem is that the user may not need all this information at any specific time. As a result, the user may not be able to easily find the information that is needed when working on a particular activity or task. In addition, having a large amount of information open in a window causes the displayed information to be reduced in size in order for all the information to fit within the window. This makes it more difficult for the user to find the information that is needed when working on a particular activity or task.

The techniques and teachings of the present disclosure provide the ability for a computing device to coordinate display of resources in a workspace in response to a current activity to be completed by a user of the computing device. This solution enables users to maximize their use of the valuable, but yet limited display space of computing devices. This is particularly true as users demand more and more sophisticated functionality in computing devices of smaller and smaller size. For instance, mobile devices, in which screen space is particularly limited by the constraints of the device's physical design, now offer as much, if not more, functionality than desktop computing devices.

The additional functionality of these devices is often diminished by a device's lack of screen space in which to fully and clearly display applications or windows when several other windows, tabs, or applications are also displayed at one time. This solution also declutters display screens in such a manner as to make computing devices more user-friendly and to drive user productivity.

To this end, the techniques disclosed herein allow for easy identification of resources of interest from amongst numerous other resources in which a user interacts with on a daily basis. No longer are users required to constantly open and close windows or tabs of applications or otherwise hunt and search for a window, tab, or application of interest.

Similarly, users no longer have to take the additional, non-productive, and deliberative steps of closing, opening, minimizing, or maximizing windows, tabs, or applications to adjust display areas to accomplish a current task or new activity. Instead, the solution described herein, determines context of the current activity. Based on the determined context, the computing device displays the resources needed to complete the current activity while hiding the resources that are not needed. When a user changes from one working context to another, this behavior may be tracked so that display of the resources for the next activity will be adjusted accordingly.

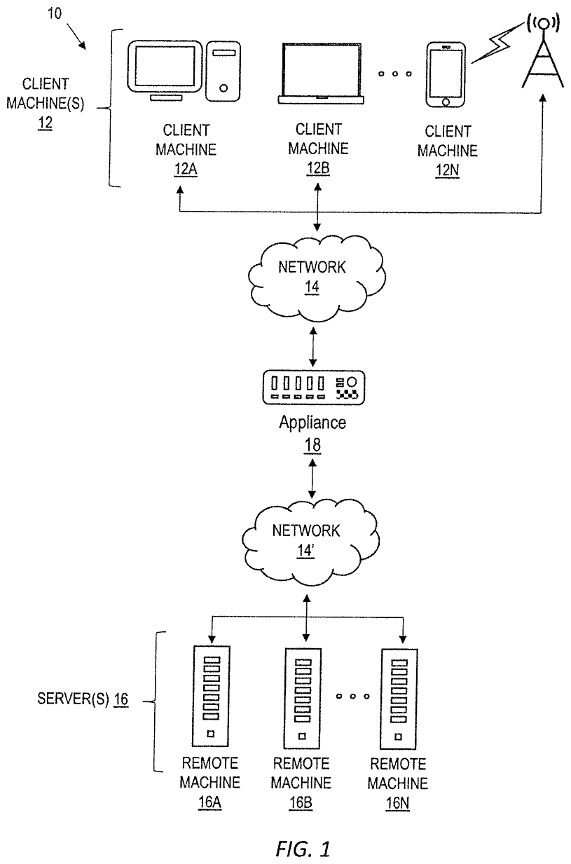

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 18 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

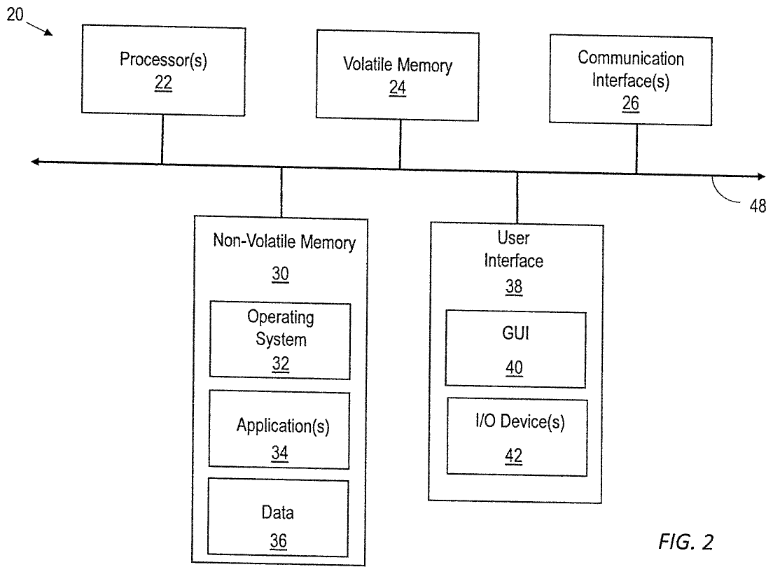

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Fla. (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

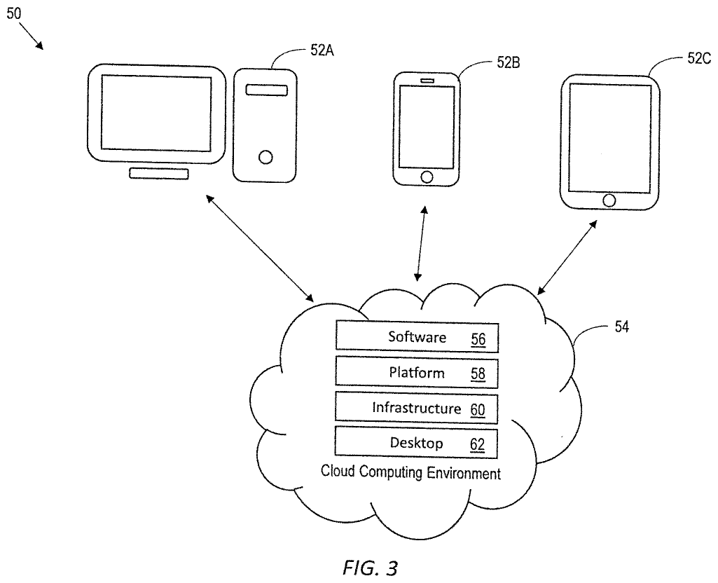

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft ONEDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

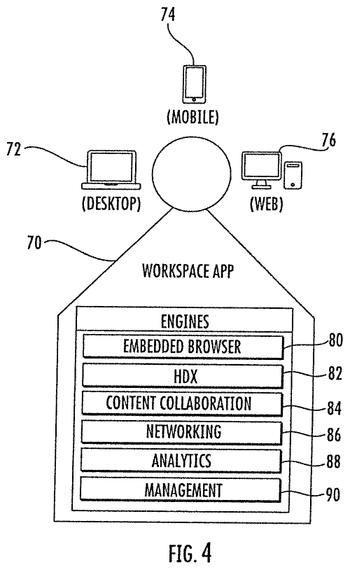

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

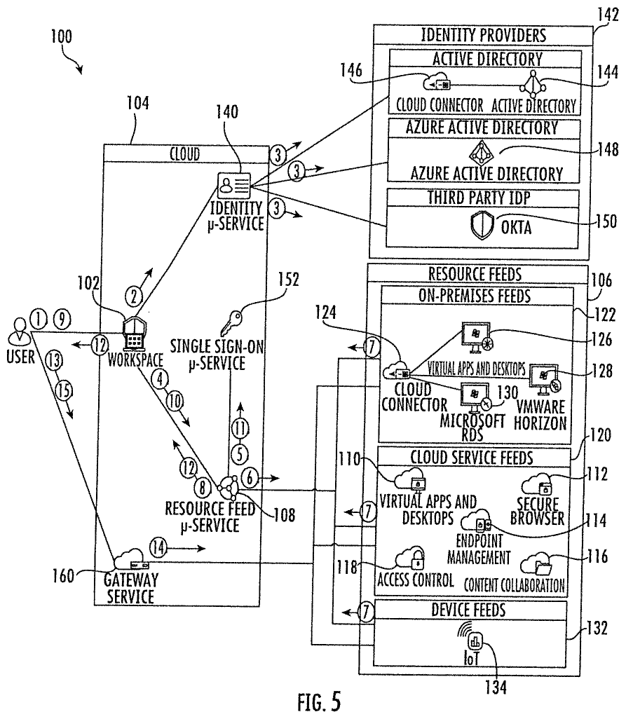

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds ‘continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

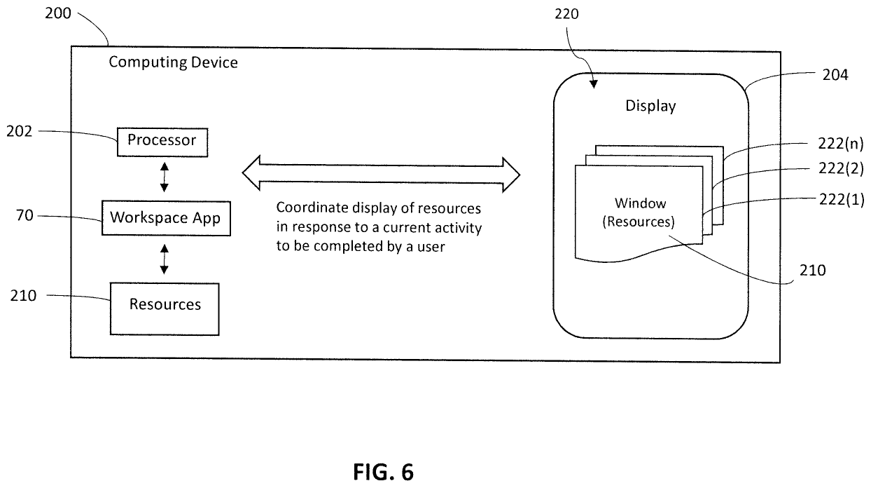

Referring now to FIG. 6, the illustrated computing device 200 is configured to coordinate display of resources 210 in a display area 220 on a display 204 in response to a current activity to be completed by a user of the computing device 200. The display area 220 typically includes a grouping of windows 222(1)-222(n) on the display 204, and the resources 210 are displayed in one or more of the windows 222(1)-222(n). The display area 220 may also be referred to as a workspace, and the resources 210 may also be referred to as workspace resources.

The windows 222(1)-222(n) may be generally referred to as windows 222. A window 222 is part of a graphical user interface (GUI) for using data. In the window 222, the user can manipulate one or more of the resources 210 presented in the window 222 to manage, generate and edit the data.

The processor 202 interfaces with the workspace app 70 to provide the resources 210. The workspace app 70, as discussed above, may be generally referred to as an app 70. There are many different categories of resources, including desktops, which may be a local desktop or a virtual desktop, and applications, which may be SaaS apps, web apps or virtual apps. Another category is files and data, which may be stored in numerous repositories. Yet other categories include browser tabs, emails, messaging channels, etc.

Efficiency of the user is improved by determining resources 210 needed for the current activity (e.g., to complete an action with use of the resource 210), and display those resources while hiding the resources not needed. The computing device 200 includes a display 204, and a processor 202 coupled to the display.

The processor 202 is configured to display at least one window 222, and individual windows have one or more resources 210 displayed therein. The processor 202 determines a current activity to be completed by a user of the computing device 200, and determines which of the displayed resources 210 are needed to complete the current activity. The processor 202 continues to display in the windows 222 the resources 210 needed to complete the current activity, and hide the remaining resources from being displayed in the windows 222.

A current activity is an activity that the user is performing or is to perform at the present time. A current activity may be the user discussing a topic with someone else, and the user wants to focus on the topic being discussed. Another current activity may be the user browsing web pages, and the user wants to focus on the applications and contents that are related to what the user is browsing. Another current activity could be a meeting that is scheduled for the user to particulate in. Yet another current activity may be when the user currently has a task flagged as “In Progress.” Example task systems include a Jira ticket system, a Wrike project management system, etc.

As will be described in detail below, the computing device 200 may be selectively placed or otherwise operated in a focused mode to coordinate display of the resources 210 in the display area 220. The focused mode may be applied to the plurality of windows 222(1)-222(n) in the display area 220, or to a single window 222(1) within the display area 220. The display area 220 may be a desktop workspace, a mobile workspace or a cloud workspace.

As will described in more detail below, the focused mode is the overall process of determining the resources 210 needed for the current activity (e.g., to complete an action with use of the resource 210), and display those resources while hiding the resources not needed. As will described in more detail below, the focused mode is to focus on the current activity.

The focused mode may be automatically set by the user so that when the user changes from one activity to another activity, the behavior will be tracked so that display of the corresponding resources 210 will adjust automatically for the most current activity. In response to the focused mode being automatically set, the focused mode is related to both tracking the user's activities, and adjusting display of the corresponding resources 210.

Alternatively, the focused mode may be manually triggered or set by the user while in a particular activity. In response to the focused mode being manually triggered, the focused mode is not related to tracking the user's activities, but instead, adjusting display of the corresponding resources 210 for the most current activity.

The mechanism supporting the focused mode is the workspace app 70. The workspace app 70 accesses at least one data source accessible to the computing device 200 to determine a context of the activity to be completed. Context refers to the parts of a written discourse that surround a word or passage and can throw light on its meaning. In other words, context is the parts of a written (or spoken) statement that precede or follow a specific word or passage, usually influencing its meaning or effect.

Example data sources are meeting schedules, issue and change request tracking tasks (e.g., JIRA), to do reminders, and user history behavior analysis. At least one identifier for use with determining the context of the activity to be completed is identified by the workspace app 70. An example identifier is a keyword that serves as a key, as to the meaning of another word, a sentence, passage, or the like. In other examples, the identifier may be an image or marking.

After the context of the current activity has been determined, then the workspace app 70 reads metadata of the available resources 210 to determine what resources should be displayed for the user. As provided in more detail below, example metadata includes application names, browser tab titles, filenames, etc.

As an alternative to reading metadata, a matching algorithm may be used to determine what resources should be displayed for the user. The matching algorithm may be based on historical data across different users. An example is as follows:

```
Example: [{“application”: “Workspace”, “items”:
    [{“name”: “MS PowerPoint”, “type”: “app”},
    {“name”: “MS PowerPoint”, “type”: “app”},
    {“name”: “MS Visio”, “type”: “app”},
    {“name”: “My Prototype Draft.ppt”, “type”:
  “file”},
    {“name”: “test.txt”, “type”: “file”},
    {“name”: “Windows 10”, “type”: “desktop”}]},
        [{“application”: “Chrome”, “items”: [
            {“name”: “Page Title A”,
      “type”: “tab”}
            {“name”: “Page Title B”,
      “type”: “tab”}]
          }].
```

If a user is creating a presentation, for example, then the user probably would likely need MS Power Point. And if the presentation preparation task is named “My Prototype,” for example, then the user probably would likely need the file named My Prototype Draft.ppt. The matching algorithm may be a full text matching algorithm, for example. If enough historical data is available, then a more powerful algorithm may be used, such as a collaborative filtering algorithm. This type of algorithm examines more than the user's history data by also determining or predicting the resources to be used by the user.

Collaborative filtering has two senses, a narrow one and a more general one. In the narrower sense, collaborative filtering is a method of making automatic predictions (filtering) about the interests of a user by collecting preferences or taste information from many users collaborating. The underlying assumption of the collaborative filtering approach is that if a person A has the same opinion as a person B on an issue, A is more likely to have B's opinion on a different issue than that of a randomly chosen person.

For example, a collaborative filtering recommendation system for television tastes could make predictions about which television show a user should like given a partial list of that user's tastes (likes or dislikes). Note that these predictions are specific to the user, but use information gleaned from many users. This differs from the simpler approach of giving an average (non-specific) score for each item of interest, for example based on its number of votes.

In the more general sense, collaborative filtering is the process of filtering for information or patterns using techniques involving collaboration among multiple users, agents, viewpoints, data sources, etc. Applications of collaborative filtering typically involve very large data sets. Collaborative filtering methods have been applied to many different kinds of data including: sensing and monitoring data, such as in mineral exploration, environmental sensing over large areas or multiple sensors; financial data, such as financial service institutions that integrate many financial sources; or in electronic commerce and web applications where the focus is on user data, etc.

After the metadata of the available resources 210 have been read, the workspace app 70 instructs the operating system to re-render the workspace 220 to display the resources 210 needed for the current activity while hiding the resources 210 that are not needed. As discussed below, these instructions are defined to send the computed output (i.e., resource resources needed) to the rendering systems. One example UI rendering system may be configured as a customized browser extension that controls the browser display. Alternatively, such a function could be built into the workspace app 70 to control the display in Citrix Workspace. Yet another example UI rendering system is an operating system service that controls the native applications and display of the windows, including hidden, minimization, and other functions.

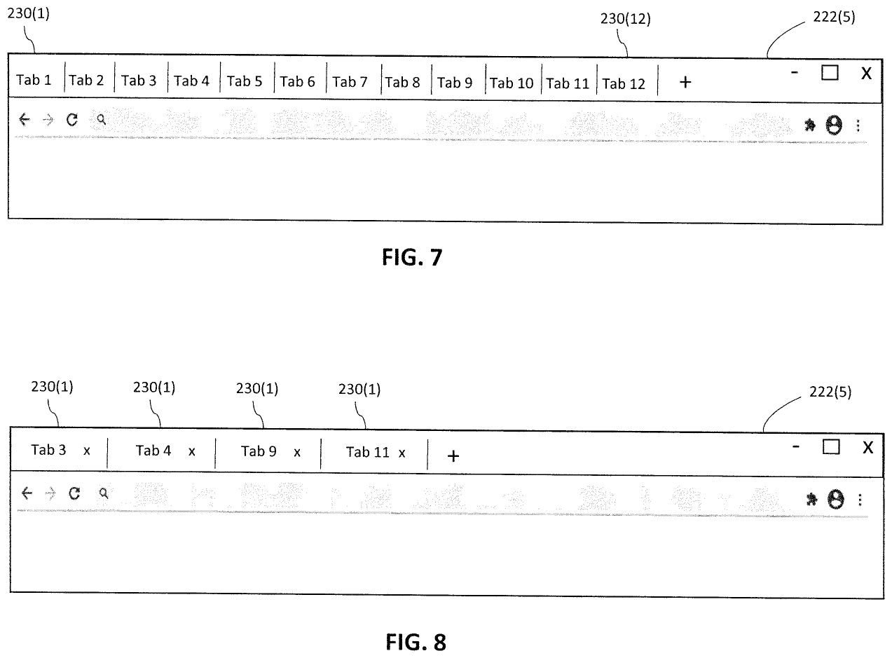

The number of resources 210 being displayed generally increases throughout the day as the user moves from one activity to another while leaving open the resources 210 used in previous activities. As noted above, the focused mode may be applied to a single window 222 within the workspace 220. For example, a typical scenario is that a user has too many browser tabs 230(1)-230(12) opened because of other activities the user was previously working on, as shown in FIG. 7. Browser tabs 230(1)-230(12) may be generally referred to as browser tabs 230.

In this scenario, the user cannot easily find the pages needed for the current activity to be performed because the content of many of the pages may not be shown, and/or descriptions shown within the tab elements of each page are now truncated and cannot be fully read. In the focused mode, the browser tabs 230 not related to the current activity being performed by the user will be hidden, as illustrated in FIG. 8. Tabs 3, 4, 9 and 11 are associated with the current activity, while tabs 1-2, 5-8, 10, 12 are not associated with the current activity. As a result of the focused mode, the user can now easily find the pages needed for the current activity to be performed, as evidenced by the illustration shown in FIG. 8. Moreover, the size of the displayed tabs in the focused mode are increased as a result of the other tabs being hidden. The descriptions provided by the displayed tabs can now be seen and easily read by the user.

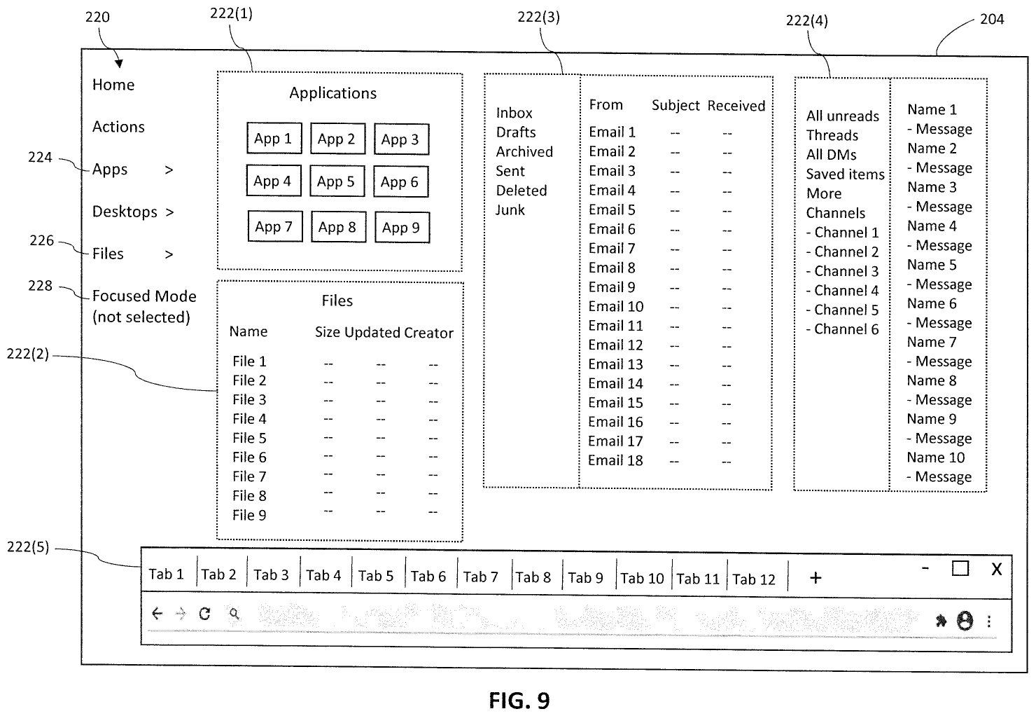

As also noted above, the focused mode may be applied to the entire workspace 220 on a desktop, as illustrated in FIG. 9. In the illustrated workspace 220, the user may have a number of windows 222(1)-222(5) opened.

In response to the user selecting the portion of menu that includes apps 224, window 222(1) provides all of the apps that are available to the user. Similarly, in response to the user selecting the portion of the menu that includes files 226, window 222(2) provides all of the apps files that are available to the user. Window 222(3) is for emails, and includes a large number of emails in the inbox. Window 222(4) is for instant messaging, and includes a large number of messages and channels. Window 222(5) is for browser tabs, and includes a large number of browser tabs 230(1)-230(12).

In this scenario, the current activity to be completed by the user is to generate a budget for an upcoming project. With all of the available resources 210 that can be displayed, the user cannot easily find the resources 210 needed for generating the budget.

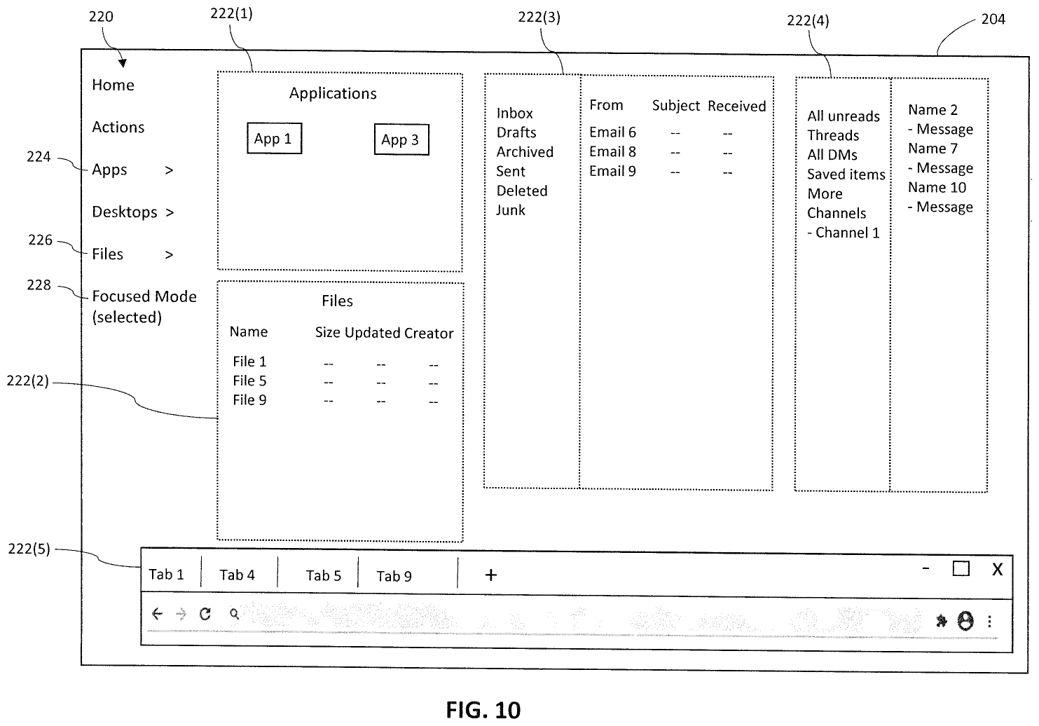

The user may select the focused mode via the focused mode 228 of the menu shown. In the focused mode, the resources 210 needed for generating the budget may be an Excel application (app 1) and a PowerPoint application (app 3), an excel file (file 1) and two PowerPoint files (files 5, 9), three emails (emails 6, 8, 9) directed to the budget, instant messages (messages 2, 7, 10) and one channel (channel 1) also directed to the budget, and four browser tabs (tabs 1, 4, 5, 9) providing information on the budget. As a result of the focused mode, the user can now easily find the resources needed to generate the budget, as shown in FIG. 10.

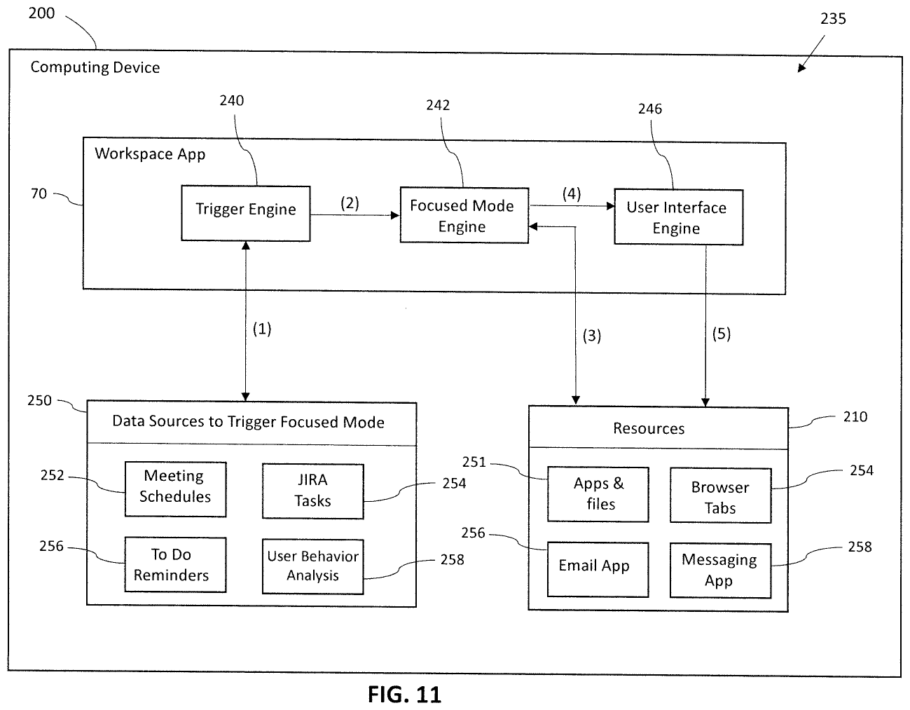

Referring now to FIG. 11, a block diagram of the system architecture 235 for providing the focused mode for the computing device 200 will be discussed. The various boxes illustrated in FIG. 11 are within the computing device 200. In particular, the workspace app 70 is configured to coordinate display of resources 210 in a workspace 220 in response to a current activity to be completed by a user of the computing device 200. To operate in the focused mode, the workspace app 70 includes a trigger engine 240, a focused mode engine 242, and a user interface (UI) engine 246.

The trigger engine 240 reads the data sources 250 accessible to the computing device 200 that can be used to understand the current activity of the user, as represented by line (1). The trigger engine 240 is to pull data from the data sources 250 to find out the current activity to be performed by the user. Data sources include, but are not limited to, meeting schedules 252 for the user, issue and change request tracking tasks 254 (e.g., JIRA tasks) for the user, to do reminders 256 for the user, and user history behavior analysis 258.

In one example, if a project planning meeting is scheduled for the user at 10 am, then the focused mode will be triggered at this time. The context of the meeting may be determined based on key words and terms describing or associated with the scheduled project planning meeting. The trigger engine 240 provides context of the scheduled project planning meeting to the focused mode engine 242 where applications and contents that are related to the current meeting are to be displayed by the UI engine 246 while other applications that are unrelated to the meeting are not.

In another example, the user has an assigned issue and change request tracking task that is estimated to take 2 hours to complete, and the deadline to complete the task is within the next 2.5 hours. The context of the task may be determined based on key words and terms describing or associated with the task. The trigger engine 240 provides context of the task to the focused mode engine 242 where only applications and contents that are related to this task are to be displayed by the UI engine 246 in anticipation of the user working on the task.

In yet another example, the user regularly works on a weekly report on Friday morning between 10-11 am. This pattern of past activities performed by the user is determined by the workspace app 70 based on user history behavior analysis 258. On Friday morning at approximately 10 am, the trigger engine 240 determines that the focused mode should be enabled for the user. The context of the weekly report may be determined based on key words and terms describing or associated with the weekly report. The trigger engine 240 provides context of the weekly report to the focused mode engine 242 where applications and contents that are related to the weekly report are to be displayed by the UI engine 246 in anticipation of the user working on the weekly report.

In the above examples, the trigger engine 240 may be set to periodically pull data from the data sources 250 based on the user having selected the focused mode. As an alternative to periodically pulling data, the data may be continuously pulled from the data sources 250 in some cases. In other cases, the data may be pulled from the data sources 250 in response to a change in the data sources. In yet other cases, the trigger engine 240 may be manually activated by the user to pull data from the data sources 250 based on a current activity to be performed by the user.

In one example, the user may be discussing a particular topic with group members via a messaging app. In response to the user manually activating the trigger engine 240, the context of the topic is determined based on key words and terms describing or associated with the topic. The trigger engine 240 provides context of the topic to the focused mode engine 242 where only applications and contents that are related to this topic are to be displayed by the UI engine 246 in anticipation of the user working on the task.

In another example, the user is browsing web pages. In response to the user manually activating the trigger engine 240, the context of the most recent web pages is determined based on key words and terms describing or associated with the web pages. The trigger engine 240 provides context of the web pages to the focused mode engine 242 where applications and contents that are related to the web pages are to be displayed by the UI engine 246 in anticipation of the user working on the task while other non-related applications are not.

As discussed above, the focused mode engine 242 is enabled by output of the trigger engine 240. The focused mode engine 242 has two inputs. Input 1 to the focused mode engine 242 is the context data from the trigger engine 240, as represented by line (2). As an example, the current activity to be performed by the user is a scheduled meeting. In this case, the context data may be in the format of the following:
{“type”: “meeting”, “keywords”: [“Product X”, “Prototype Design”, “PPT”]}.

Input 2 for the focused mode engine 242 is based on reading the metadata from the available resources 210, as represented by line (3). Metadata is data about data, i.e., a description and context of the available resources 210. Metadata allows the focused mode engine 242 to organize, find and understand data associated with the respective resources 210.

A few examples of metadata will now be provided. For files, all the fields being displayed by each file in a file explorer is metadata. The actual data is inside those files. Metadata includes file name, type, size, creation date and time, and last modification date and time. For web pages, metadata includes page title, page description, and icons. For documents, metadata includes title, subject, author, company, status, creation date and time, last modification date and time, and number of pages. For emails, the metadata are hidden in the message header and are not visible. This metadata includes subject, from, to, date and time sent, sending and receiving server names and IPs, format (plain text of HTLM), and anti-spam software details. For spreadsheets, metadata includes tab names, table names, column names, and user comments.

For discussion purposes, the available resources 210 may be generally referred to as content applications. Below are two examples.

The first example is directed to applications and files generally indicated by reference 251:

```
Example: [{“application”: “Workspace”, “items”:
  [{“name”: “MS PowerPoint”, “type”: “app”},
  {“name”: “MS Visio”, “type”: “app”},
  {“name”: “My Prototype Draft.ppt”, “type”:
  “file”},
  {“name”: “test.txt”, “type”: “file”},
  {“name”: “Windows 10”, “type”: “desktop”}]}.
```

The second example is directed to the browser tabs 254:

```
Example: {“application”: “Chrome”, “items”:
  [{“name”: “Page Title A”, “type”: “tab”}
  {“name”: “Page Title B”, “type”: “tab”}]
  }].
```

The output of the focused mode engine 242 is a list of applications and contents that should be displayed, as represented by line (4):

```
Example: [{“application”: “Citrix Workspace”, “items”:
    [{“name”: “MS PowerPoint”, “type”: “app”},
    {“name”: “MS Visio”, “type”: “app”},
    {“name”: “My Prototype Draft.ppt”, “type”:
    “file”}]
  [{“application”: “Chrome”, “items”:
    [{“name”: “Page Title B”, “type”: “tab”}]
    }].
```

The output of the focused mode engine 242 may provide dynamic adjustments to the UI engine 246, as represented by line (4). For example, when a user changes from one working context to another, the behavior will be tracked and the corresponding apps will be adjusted automatically.

In response to receiving the output from the focused mode engine 242, the UI engine 246 instructs the operating system and applications to switch to the focused mode, as represented by line (5). In this focused mode, the necessary or otherwise relevant applications and contents are visible to the user while other non-relevant content is not visible. The UI engine 246 also has the ability to switch on and off the focused mode manually by user. The UI Engine 246 may be run as plugins of applications to render the applications UI.

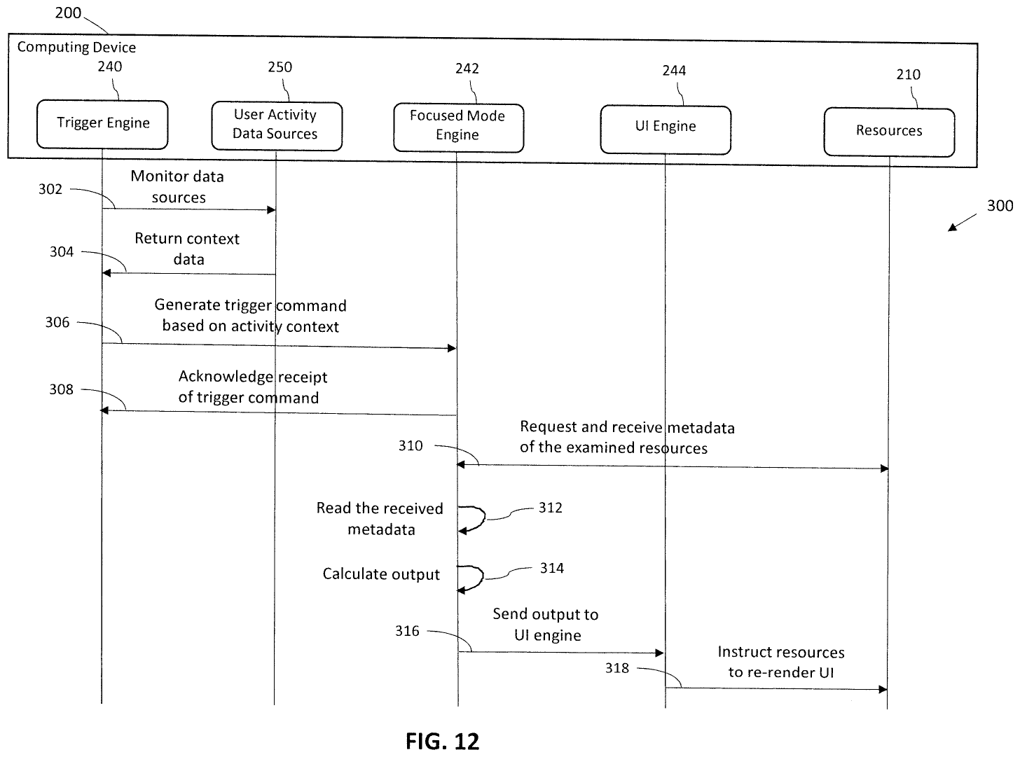

A sequence diagram 300 providing the focused mode for the computing device 200 will be discussed in reference to FIG. 12. From the start, the trigger engine 240 monitors the data sources 250 accessible to the computing device 200 at line 302. The trigger engine 240 pulls or otherwise receives data from the data sources 250 at line 304 that can be used to understand the current activities or works the user is focusing on. As noted above, the trigger engine 240 may periodically pull or receive the data, or may manually pull the data in response to user input.

In response to the trigger engine 240 determining that the focused mode should be enabled or switched on, a trigger command is sent to the focused mode engine 242 along with the user activity context at line 306. The focused mode engine 242 provides to the trigger engine 240 acknowledgement on receipt of the trigger command at line 308.

The focused mode engine 242 requests and receives metadata from the resources 210 at line 310. The focused mode engine 242 reads metadata of the examined resources 210 at line 312. The focused mode engine 242 calculates an output based on current user activity and applications information/items at line 314.

The focused mode engine 242 calculates the output to be provided to the UI engine 244 at line 314. The focused mode engine 242 then sends the output to the UI engine 244 at line 316. The UI engine 244 instructs the resources 210 to re-render the UI based on the calculated output from focused mode engine 242 at line 318.

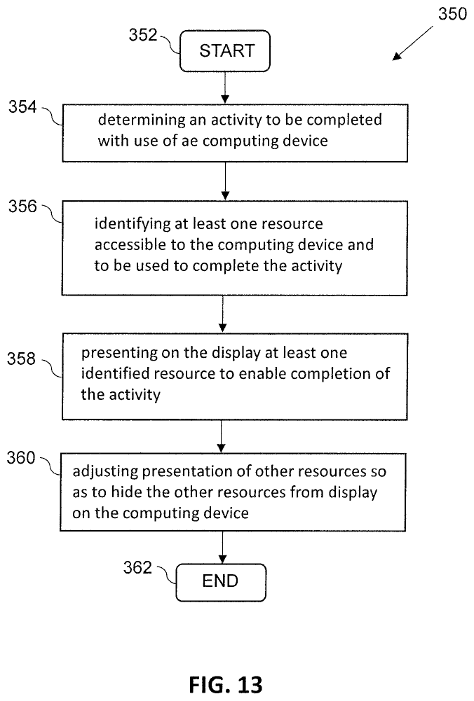

Referring now to FIG. 13, a flow diagram 350 illustrating coordinating display of the resources 210 in a workspace 220 in response to a current activity to be completed by a user of the computing device 200 will be discussed. From the start (Block 352), an activity to be completed with use of the computing device 200 is determined at Block 354. At least one resource 210 accessible to the computing device 200 and to be used to complete the activity is identified at Block 356. At least one identified resource 210 to enable completion of the activity is presented on the display 204 at Block 358. Presentation of other resources is adjusted at Block 360 so as to hide the other resources from display on the computing device 210. The method ends at Block 362.

As will be appreciated by one of skill in the art upon reading the above disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

That which is claimed:

1. A computing device comprising:
a display; and
a processor coupled to said display and configured to perform the following:
determine an activity to be completed with use of the computing device,
identify at least one resource accessible to the computing device and to be used to complete the activity,
present on said display at least one identified resource to enable completion of the activity; and
adjust presentation of other resources so as to hide the other resources from display on the computing device.

2. The computing device according to claim 1 wherein said processor is further configured to perform the following:
display a plurality of resources;
access at least one data source accessible to the computing device to determine a context of the activity to be completed; and
read metadata of the plurality of displayed resources to identify the at least one resource associated with the activity to be completed based on the determined context.

3. The computing device according to claim 2 wherein said processor is further configured, in response to accessing the at least one data source, to identify at least one keyword to be used in determining the context of the activity to be completed.

4. The computing device according to claim 1 wherein the activity to be completed is a current activity, and wherein said processor is further configured to determine a next activity to be completed after the current activity has been completed, and to repeat the identify, present and adjust steps for the next activity.

5. The computing device according to claim 1 wherein said processor is further configured, in response to user input, to determine the activity to be completed.

6. The computing device according to claim 1 wherein the resources comprise at least one of desktops, applications, files, browser tabs, emails, and messaging channels.

7. The computing device according to claim 6 wherein the resources are displayed in a plurality of respective windows.

8. The computing device according to claim 1 wherein said processor is further configured to perform the following:
track scheduled meetings accessible to the computing device, with the scheduled meetings for a user of the computing device; and
use one of the scheduled meetings to determine the activity to be completed.

9. The computing device according to claim 1 wherein said processor is further configured to perform the following:
track tasks accessible to the computing device, with the tasks to be performed by a user of the computing device; and
use one of the tasks to determine the activity to be completed.

10. The computing device according to claim 1 wherein said processor is further configured to perform the following:
track past activities performed by a user of the computing device; and
use one of the past activities to anticipate the activity to be completed.

11. A method comprising:
determining an activity to be completed with use of a computing device;
identifying at least one resource accessible to the computing device and to be used to complete the activity;
presenting on the display at least one identified resource to enable completion of the activity; and
adjusting presentation of other resources so as to hide the other resources from display on the computing device.

12. The method according to claim 11 further comprising:
displaying a plurality of resources;
accessing at least one data source accessible to the computing device to determine a context of the activity to be completed; and
reading metadata of the plurality of displayed resources to identify the at least one resource associated with the activity to be completed based on the determined context.

13. The method according to claim 12 further comprising, in response to accessing the at least one data source, to identify at least one keyword to be used in determining the context of the activity to be completed.

14. The method according to claim 11 wherein the activity to be completed is a current activity, and further comprising determining a next activity to be completed after the current activity has been completed, and to repeat the identifying, presenting and adjusting steps for the next activity.

15. The method according to claim 11 further comprising, in response to user input, determining the activity to be completed.

16. The method device according to claim 11 wherein the resources comprise at least one of desktops, applications, files, browser tabs, emails, and messaging channels.

17. The method according to claim 11 further comprising:
tracking scheduled meetings accessible to the computing device, with the scheduled meetings for a user of the computing device; and
using one of the scheduled meetings to determine the activity to be completed.

18. The method according to claim 11 further comprising:
tracking tasks accessible to the computing device, with the tasks to be performed by a user of the computing device; and
using one of the tasks to determine the activity to be completed.

19. The method according to claim 11 further comprising:
tracking past activities performed by a user of the computing device; and
using one of the past activities to anticipate the activity to be completed.

20. A non-transitory computer readable medium for a computing device, and with the non-transitory computer readable medium having a plurality of computer executable instructions for causing the computing device to perform steps comprising:
determining an activity to be completed with use of ae computing device;
identifying at least one resource accessible to the computing device and to be used to complete the activity;
presenting on the display at least one identified resource to enable completion of the activity; and
adjusting presentation of other resources so as to hide the other resources from display on the computing device.
